(19) United States
(12) Patent Application Publication
(10) Pub. No.: US 2026/0084599 A1
(43) Pub. Date: Mar. 26, 2026

(54) SEAT BACK

(71) Applicant: TOYOTA BOSHOKU KABUSHIKI KAISHA, Aichi-ken (JP)

(72) Inventors: Masahiko IYODA, Nagakute-shi (JP); Takeshi USHIYAMA, Toyota-shi (JP); Yuji NAKANO, Nissin-shi (JP)

(73) Assignee: TOYOTA BOSHOKU KABUSHIKI KAISHA, Aichi-ken (JP)

(21) Appl. No.: 19/324,263

(22) Filed: Sep. 10, 2025

(30) Foreign Application Priority Data
Sep. 20, 2024 (JP) 2024-163547

(51) Int. Cl. B60N 2/68; B60N 2/58; B60N 2/90; B60R 21/215; B60R 21/231

(52) U.S. Cl. CPC B60N 2/68; B60N 2/986; B60R 21/215; B60N 2002/5808; B60R 2021/23146

(57) ABSTRACT

A seat back has a frame and a cushion member. The cushion member has a central main member and two side members. Each member includes a pad, a cover, and a support member. A pair of right and left engaging portions are located on the upper part of the main support member. The upper part of each of the side support members has an engaged portion. Each engaging portion engages against one of the respective engaged portions, and the main support member and each side support member are disabled from moving relative to the frame in the front-rear and right-left directions.

### CROSS-REFERENCE TO RELATED APPLICATION

This application claims priority to Japanese patent application serial number 2024-163547 filed Sep. 20, 2024, the contents of which are incorporated herein by reference in its entirety for all purposes.

### TECHNICAL FIELD

The present disclosure relates to a seat back. In particular, the present disclosure relates to a seat back in which a cushion member elastically supporting a seater is divided into three parts in a seat width direction and mounted on a frame.

### BACKGROUND

A seat back for a vehicle seat, such as an automobile, is known to have a seat back cover, divided into three parts in the seat width direction and assembled to a seat back frame. For example, a prior art discloses a seat back having a seat back main member, which is the central portion in the seat width direction, and two seat back side members, which are located on both sides of the seat back main member. Each of these is attached to a seat back frame separately.

According to the automobile seat described in the above prior art, the main member and the two side members are individually assembled with the frame from the front. Therefore, the pre-formed main member and side members can be attached to the frame from front, which makes assemble easy. However, since the main member and side members are attached to the frame individually, there is a risk of gaps being generated between the main member and side members, which could damage the appearance of the seat back.

Therefore, there has been a need for a seat back that prevents damage to the appearance of the seat back, in which the cushion member supporting a pad covered with a cover with a support member is divided into three parts in the seat width direction and attached to the frame.

### SUMMARY

A seat back is disclosed, comprising a frame that forms a framework and a cushion member attached to the frame to elastically support a seater. The cushion member includes a main member at the center and a pair of side members on both sides. The main member has a main pad, a main cover, and a main support member. The main support member is attached to the frame-side of the main pad and supports it. The side member includes a side pad, a side cover, and a side support member, with the side support member attached to the frame-side of the side pad and supporting it. The upper part of the main support member features a pair of right and left engaging portions. Each of the side support members has an engaged portion on its upper part, which is designed to engage with one of the engaging portions. When the main support member and each side support members are attached to the frame, these engaging portions interlock with their respective engaged portions, preventing relative movement in the front-rear and right-left directions. This structure ensures that the gap between the upper parts of the main and side members remains constant, thus suppressing damage to the seat back's appearance.

Therefore, with the main member and each side member attached to the frame, the upper part of the main member and the upper part of each side member cannot move relative to each other in the front-rear and right-left directions. This structure ensures that the gap between the upper parts of the main member and side members remains constant, thus suppressing damage to the seat back's appearance.

### BRIEF DESCRIPTION OF DRAWINGS

FIG. 1 is a perspective view of an automobile seat to which a seat back according to one embodiment is assembled.

FIG. 2 is a front view of the seat back of FIG. 1, wherein only a right side is shown since the shape of the seat back is symmetrical to the right and left. Only a side support member of a side member and a frame are shown.

FIG. 3 is a cross-sectional view taken along a line III-III in FIG. 2, wherein a back pad and a back cover of the side member, and a main member are shown.

FIG. 4 is a cross-sectional view taken along a line IV-IV in FIG. 2, wherein the back pad and the back cover of the side member, and the main member are shown.

FIG. 5 is an enlarged schematic diagram of a part V in FIG. 2.

FIG. 6 is a cross-sectional view taken along a line VI-VI in FIG. 5.

FIG. 7 is a cross-sectional view taken along a line VII-VII in FIG. 5.

FIG. 8 is a figure corresponding to FIG. 5 of another embodiment.

FIG. 9 is a cross-sectional view taken along a line IX-IX in FIG. 8.

FIG. 10 is a cross-sectional view taken along a line X-X in FIG. 9.

FIG. 11 is a diagonal view of FIG. 9 from the XI direction.

### DETAILED DESCRIPTION

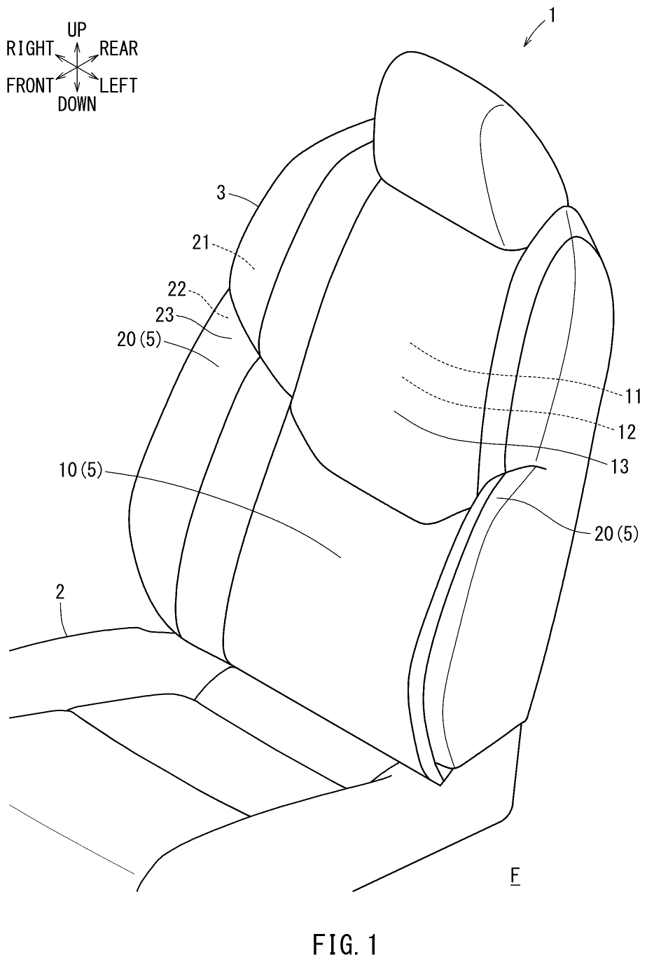

Referring to FIGS. 1 to 7, a seat back 3 of an automobile seat 1 in accordance with an embodiment of the present disclosure will be described. In the following description, explanations regarding the directions shall be based on the respective directions of up/down, front/rear, right/left as shown in each figure. Here, the up/down, front/rear, right/left directions are defined based on the automobile seat 1 when it is mounted on a floor F of the automobile. The right-left direction corresponds to a seat width direction.

As shown in FIG. 1, the automobile seat 1 has a seat cushion 2 that supports the buttocks and thighs of a seater and the seat back 3 that supports the waist and back of the seater.

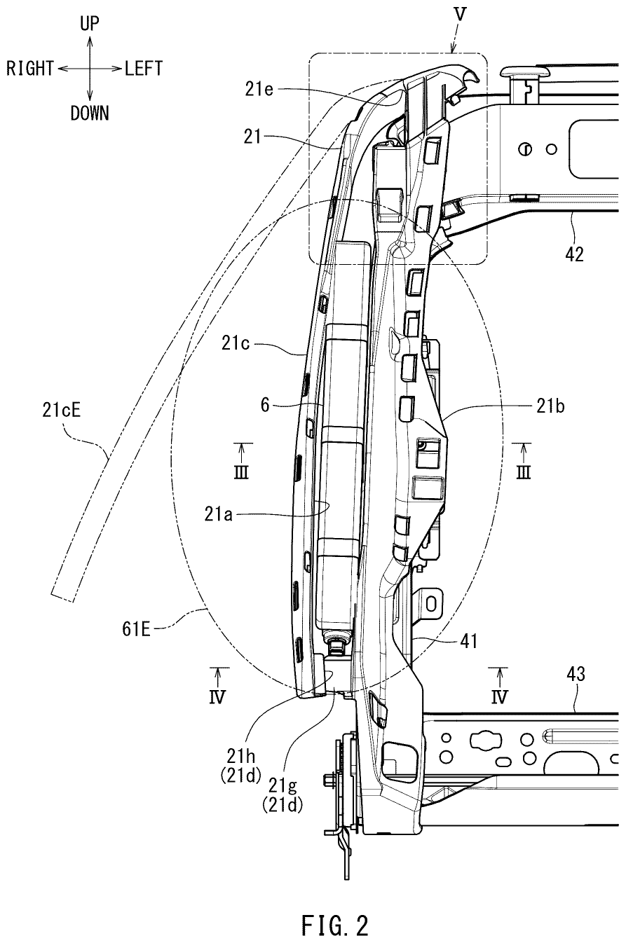

As shown in FIGS. 1 and 2, the seat back 3 has a frame 4, a cushion member 5, and a right-left pair of airbag devices 6. The frame 4 forms a framework of the seat back 3. The cushion member 5, which is assembled to the frame 4, has a cushioning function and defines the external shape of the seat back 3.

As shown in FIGS. 1 and 2, the frame 4 has a pair of side frames 41, an upper frame 42, and a lower frame 43. The side frames 41 extend vertically along the right and left sides of the seat back 3. The upper frame 42 is bridged across the upper ends of the side frames 41. The lower frame 43 is bridged across the lower ends of the side frames 41. The frame 4 is formed in the shape of a rectangular when viewed from the front. A lumbar plate (not shown) is arranged between the upper frame 42 and the lower frame 43.

As shown in FIGS. 1, 3 and 4, the cushion member 5 has a main member 10 at the central portion in the seat width direction and a right-left pair of side members 20 on both sides of the main member 10. The main member 10 supports the waist and back of the seater from the rear side. The side member 20 supports the waist and back of the seater from the side.

The main member 10 has a main support member 11, a main pad 12, and a main cover 13. The main support member 11 is typically made of resin. The main pad 12 is a cushioning body disposed on the front side of the main support member 11 and supported by the main support member 11 against the frame 4. The main cover 13 covers the main pad 12 from the front side.

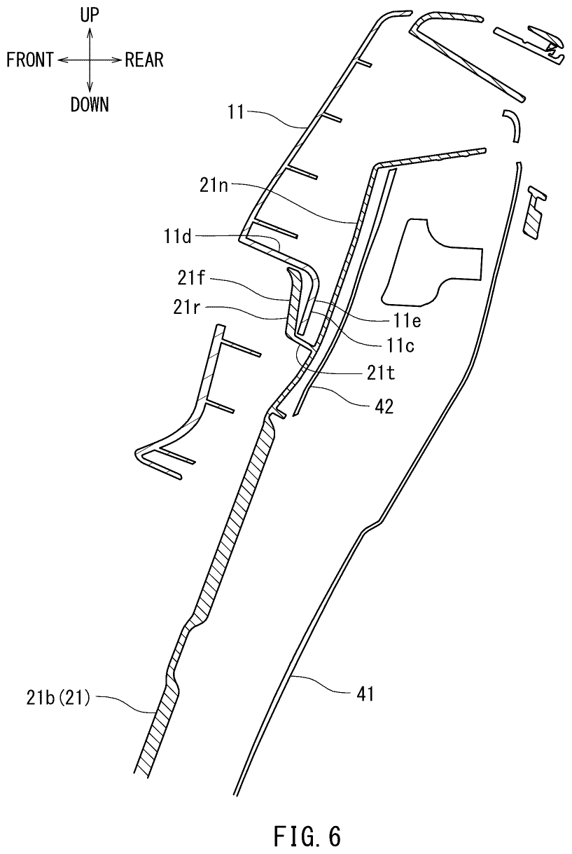

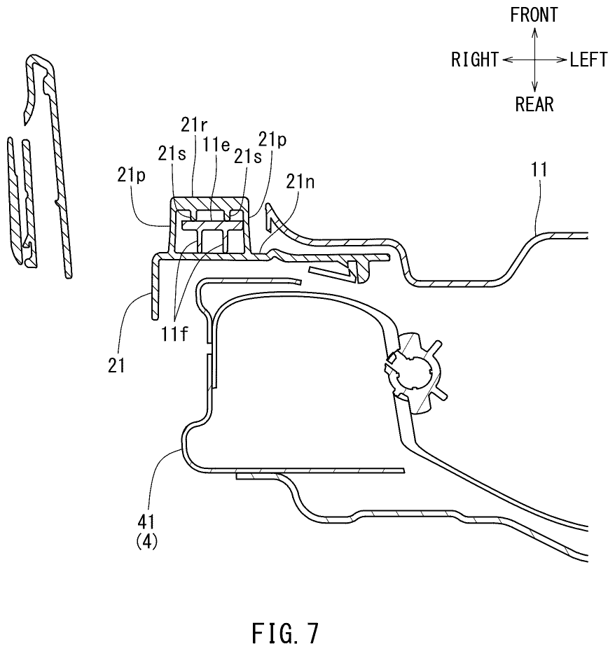

The main support member 11 has an abbreviated rectangular shape when viewed from the front, with the direction of its long axis in the vertical direction when viewed from the front. The rear surface of the upper part of the main support member 11 is fixed to the upper frame 42. The rear surface of the main support member 11 is fixed to the lumbar plate at approximately the center in the vertical direction. The rear surface of the lower part of the main support member 11 is fixed to the lower frame 43. Furthermore, an engaging portion 11c is formed on the rear surface of the left and right side in the upper part of the main support member 11. The engaging portion 11c has a hook-shape and opens downward. The engaged portion 21f has a box-shape and opens upward. As shown in FIGS. 6 and 7, the engaging portion 11c has an upper wall 11d and a lower wall 11e. The upper wall 11d extends from the rear surface of the main support member 11 toward the rear downward. The lower wall 11e extends from the rear end of the upper wall 11d downward perpendicular to the upper wall 11d. Two ribs 11f are formed on the rear surface of the lower wall 11e that are perpendicular to the lower wall 11e and extend rearward.

The main pad 12 is an elastic body made of a foam molded polyurethane resin. The main pad 12 has approximately the same external shape as the main support member 11 when viewed from the front. The main cover 13 is formed by sewing multiple pieces. The main cover 13 has a bag-shape that opens rearwardly. The main cover 13 covers the main pad 12, which is arranged on the frontside of the main support member 11, from the front side. The end portion of the opening of the main cover 13 is then engaged with the outer peripheral part of the main support member 11, forming the main member 10.

As shown in FIGS. 2 to 7, the side member 20 has a side support member 21, a side pad 22, and a side cover 23. The side support member 21 is made of resin. The side pad 22 is a cushioning body disposed on the front side of the side support member 21. The side pad 22 is supported by the side support member 21 against the frame 4. The side cover 23 covers the side pad 22 from the front side.

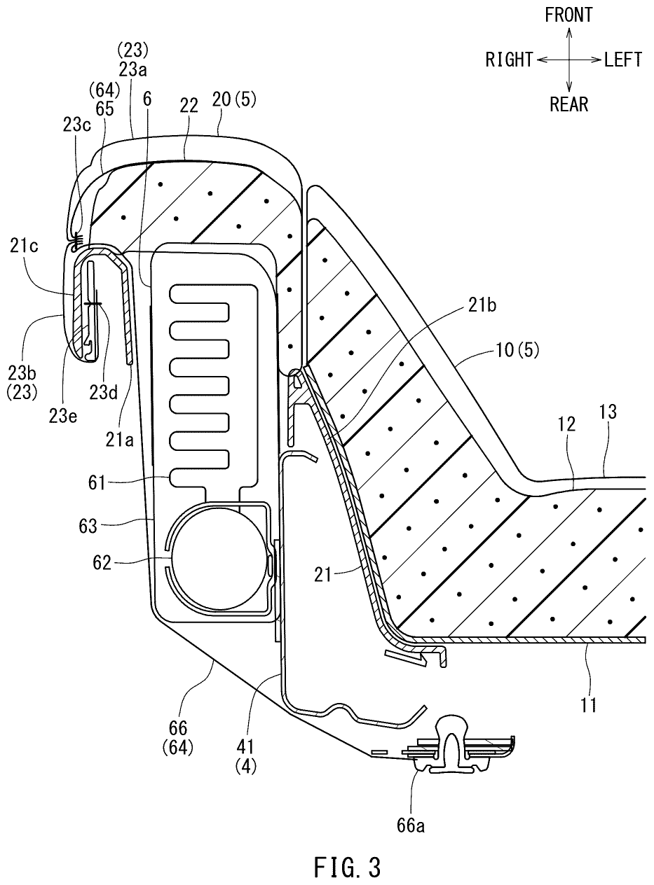

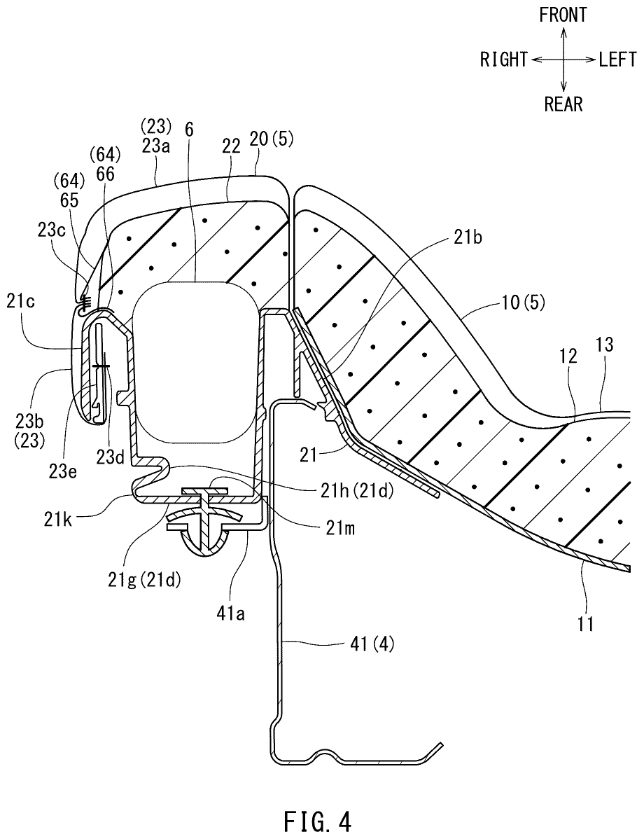

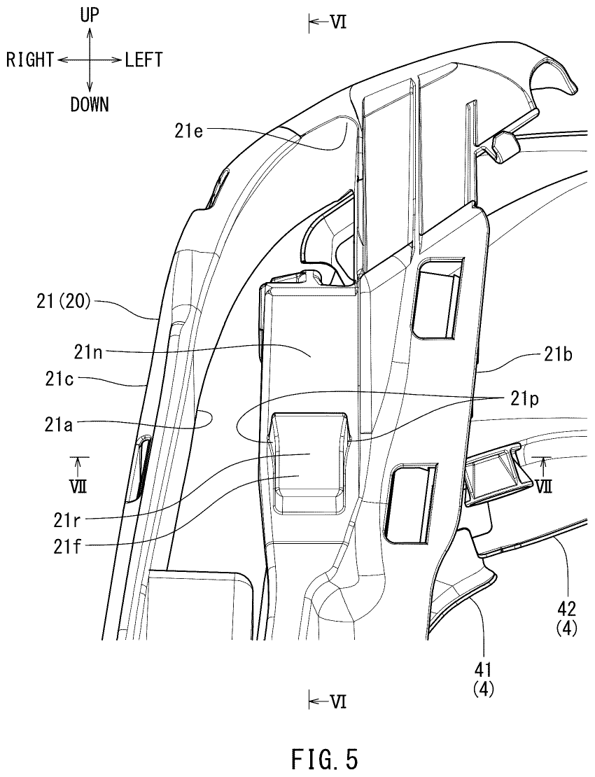

As shown in FIG. 2, the side support member 21 has a through-hole 21a in the center area in the right-left direction. The through hole 21a extends in the vertical direction and penetrates in the front-rear direction. The left side of the through hole 21a (inside the seat) has a base portion 21b extending vertically along the front side of the side frame 41. The right side of the through hole 21a (outside the seat) has a deforming portion 21c. The shape of the horizontal cross section of the deforming portion 21c is substantially U-shape opening rearwardly (see FIGS. 3 and 4). A weakened portion 21d is formed at the lower part of the through hole 21a. The lower end of the base portion 21b and the lower end of the deforming portion 21c are connected via the weakened portion 21d. The upper end of the base portion 21b and the upper end of the deforming portion 21c are connected so that the upper end of the deforming portion 21c gradually curves to the left (inwardly toward the seat) as it moves upward against the upper end of the base portion 21b. On the upper part of the through hole 21a, an R-portion 21e, which has an R-shape viewed from the front, is formed between the base portion 21b and the deforming portion 21c. As shown in FIG. 6, a box-shaped engaged portion 21f, which opens upward, is formed on the upper front surface of the base portion 21b. The engaged portion 21f is engaged with the engaging portion 11c of the main support member 11. As shown in FIGS. 5 to 7, the engaged portion 21f is formed by a flat portion 21n, which is the upper area of base portion 21b, a pair of standing plates 21p, which extends parallel and forward from the flat portion 21n, a front plate 21r, which connects the front end of each standing plate 21p and extending roughly parallel to the flat portion 21n, and a lower plate 21t, which connects the lower end of the front plate 21r and the rear end of each standing plate 21p to the flat portion 21n. The engaged portion 21f has a box shape opening upward. Two parallel ribs 21s extending perpendicular to the front plate 21r are formed on the rear surface of the front plate 21r. When the lower wall 11e of the engaging portion 11c is inserted between the two ribs 21s and the flat portion 21n, the engaging portion 11c is stopped from moving relative to the engaged portion 21f in the front-rear and right-left directions. The side support member 21 is fixed to the frame 4 at a rear surface (not shown) located approximately in the center in the vertical direction of the base portion 21b and at a weakened portion 21d.

As shown in FIGS. 2 and 4, the weakened portion 21d has an attaching portion 21g, which has a rectangular-shape viewed from the front, and a bending portion 21h, which has a Z-shaped cross-section cut in the horizontal plane. The front end of the bending portion 21h is connected to the deforming portion 21c. The rear end of the bending portion 21h is connected to the right end of the attaching portion 21g. An outer bending portion 21k, which is the bending area on the right side (outside of the seat) of the bending portion 21h, has a thinner wall thickness. Therefore, when a load toward the right direction (outside direction of the seat) is applied to the deforming portion 21c due to airbag deployment, the weakened portion 21d can be ruptured. The attaching portion 21g is fixed to a bracket 41a of the side frame 41 by a clip 21m that is passed through the clip hole (not shown).

As shown in FIGS. 3 and 4, the side pad 22 has approximately the same external shape as the side support member 21 when viewed from the front. The side pad 22 is an elastic body made of a foam molded polyurethane resin. The side pad 22 covers the front surface of the airbag device 6. The side pad 22 does not have a through hole penetrated in the front-rear direction, which corresponds to the through hole 21a. The side cover 23 is formed by sewing multiple pieces. The side cover 23 has a bag-shape that opens rearward. The side cover 23 covers the side pad 22 from the front side of the side support member 21. The opening end of the side cover 23 is then fastened to the outer peripheral part of the side support member 21, thereby the side member 20 is formed. As shown in FIG. 3, the side cover 23 has a first cover portion 23a, which covers the front and left side of the side pad 22, and a second cover portion 23b, which covers the right side of the side support member 21. The right end of the first cover portion 23a and the right front end of the second cover portion 23b are connected by a first sewing portion 23c. The left front end of the second cover portion 23b is connected to a resin plate 23e by a second sewing portion 23d.

The airbag device 6 is assembled to the outer surface of the right and left side frames 41. Since the right and left airbag devices 6 have abbreviated symmetrical shape, the airbag device 6 on the right side will be described. As shown in FIGS. 2 to 4, the airbag device 6 is vertically long box-shaped. The external shape of the airbag device 6 matches the shape of the through hole 21a of the side support member 21 when viewed from the front. The airbag device 6 has an airbag 61, an inflator 62, a case 63, and a stay cloth 64. Upon receiving a collision signal from the vehicle's ECU (not shown) the inflator 62 injects gas into the airbag 61. Therefore, the airbag 61 inflates to the front of the seat upon activation.

The case 63 is a vertical box-shaped container that houses the airbag 61 and the inflator 62 inside. The left side surface of the case 63 is fixed to the side frame 41. When the airbag 61 inflates, the case 63 is opened through a slit (not shown). Then, the airbag 61 deploys to the front of the seat.

The stay cloth 64 acts as a stretch-resistant guide, directing the deployment direction of the airbag 61. The stay cloth 64 has a front stay cloth 65 on the front side, and a rear stay cloth 66 on the rear side. On the right side, the right ends of the front stay cloth 65, first cover portion 23a, second cover portion 23b, and rear stay cloth 66 are all sewn together at the first sewing portion 23c. The left front end of the second cover portion 23b is sewn to a resin plate 23e at the second sewing portion 23d. The resin plate 23e is located inside the U-shaped deforming portion 21c of the side support member 21. Thereby, the right side of the side cover 23 is fixed to the side support member 21. For the left side, the front stay cloth 65 is secured to the frame 4 by a fixing member (not shown). Similarly, the left end of the rear stay cloth 66 is also fixed to the frame 4, but by a specific fixing member 66a.

The assembly procedure of the seat back 3 will be described. First, as shown in FIGS. 2 to 4, the airbag device 6 is assembled to the outer side of each side frame 41. Then, the pre-assembled right and left side members 20 are assembled to the frame 4. The airbag device 6 is arranged inside the side member 20 by passing the airbag device 6 through the through hole 21a of the side support member 21. Then, the left end of the front stay cloth 65 is fixed to the frame 4 by a fixing member (not shown). The left end of the rear stay cloth 66 is fixed to the frame 4 by the fixing member 66a. Next, the main member 10 is assembled to the frame 4. At this time, each engaging portion 11c of the main member 10 is engaged with the engaged portion 21f of each side member 20. Specifically, the lower wall 11e of the engaging portion 11c is inserted between the two ribs 21s and the flat portion 21n between the pair of standing plates 21p of the engaged portion 21f. Then, the engaging portion 11c is engaged with the engaged portion 21f to stop relative movement in the front-rear and right-left directions. This prevents the upper part of the main member 10 from moving relative to the upper part of the side member 20. Therefore, the rear side of the main member 10 comes into contact with the front side of the part of the side support member 21 in the upper part of the side member 20 that is not covered by the side pad 22. When removing the main member 10 and each side member 20 from the frame 4, the procedure is the reverse of the above procedure. Then, a backboard (not shown) is attached to the rear side of frame 4 to conceal the rear side thereof.

As shown in FIG. 1, the seat back 3, which is assembled as described above, is attached to the seat cushion 2 to form the automobile seat 1. The automobile seat 1 is then fixed to the floor F. In this state, when the airbag device 61 receives the signal of the vehicle collision from the ECU, the inflator 62 injects gas into the airbag 61. The airbag 61 is then inflates to the front of the seat upon activation. As shown in FIG. 2, the outer bending portion 21k (see FIG. 4) of the weakened portion 21d of the side support member 21 is ruptured during the airbag 61 deployment to a state 61E. Therefore, the deforming portion 21c of the side support member 21 turns around its upper end toward the right direction to become a deformed state 21cE. At the same time, the first sewing portion 23c is ruptured by the tensile force applied by the front stay cloth 65 and the rear stay cloth 66 in the process of the airbag 61 unfolding to become the deformed state 61E. The airbag 61 is deployed from between the first cover portion 23a and the second cover portion 23b toward the front of the seat back 3.

The embodiment configured as described above has the following effects. By attaching the main member 10 and each side member 20 to the frame 4, the upper part of the main member 10 and the upper part of each side member 20 cannot move relatively to each other in the front-back and right-left directions by engaging one of the engaging portions 11c against each engaged portion 21f. This structure ensures a constant gap between the upper part of the main member 10 and the upper part of each side member 20. Therefore, alleviates the damage to the appearance.

Further, when the main member 10 and each side member 20 are attached to the frame 4, the upper part of the main member 10 and the upper part of each side member 20 are overlapped, and one of the hook-shaped engaging portion 11c of the main support member 11 engages with each box-shaped engaged portion 21f of each side support member 21. The movement in the front-rear and right-left directions are thus restricted. This allows smooth engagement of any one of the hook-shaped engaging portions 11c with each of the engaged portions 21f. Furthermore, the gap between the upper part of the main member 10 and the upper part of each side member 20 can be kept constant more steadily. Therefore, damage to the external appearance is suppressed.

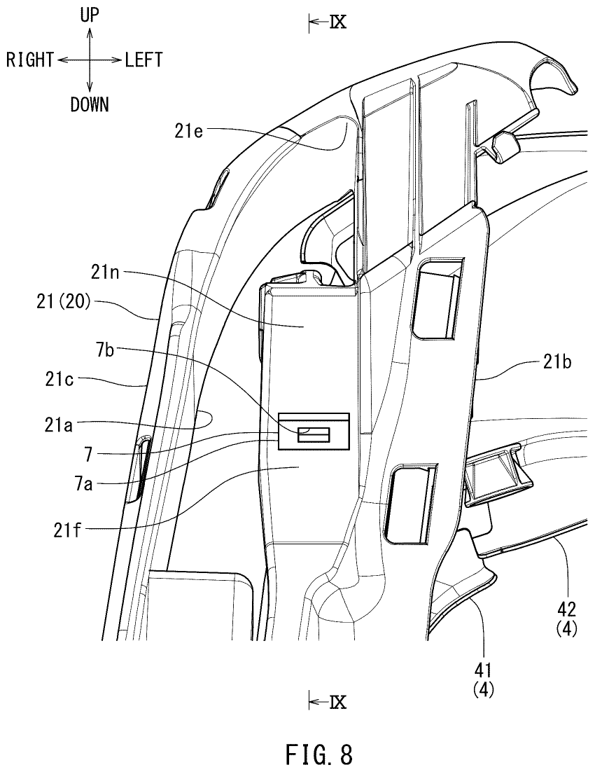

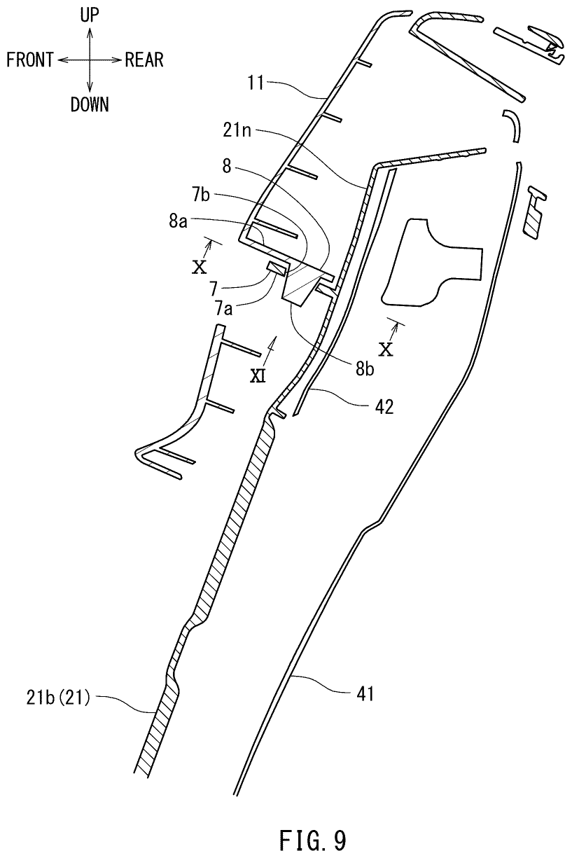

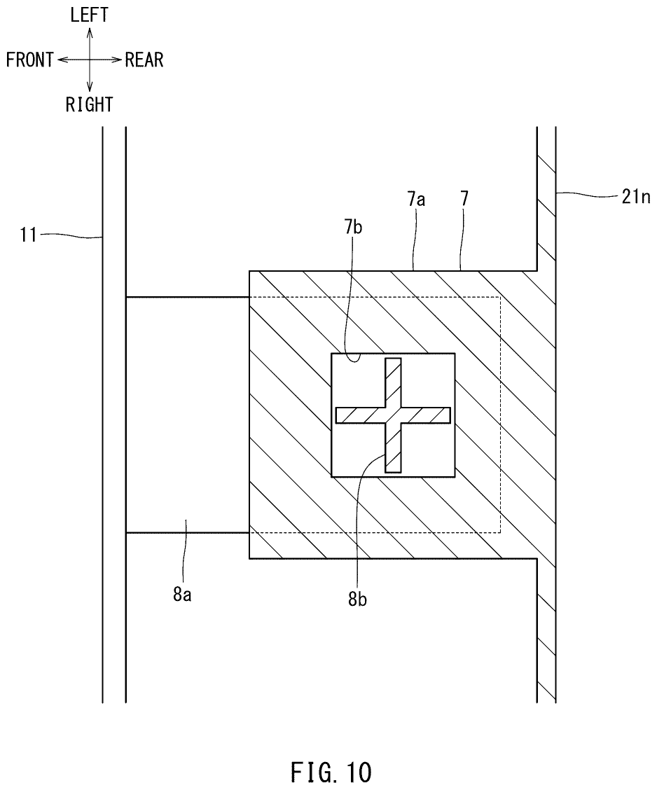

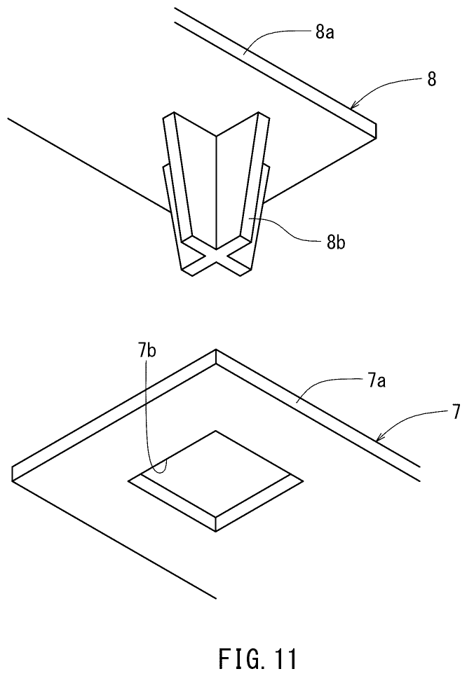

Another embodiment, as illustrated in FIGS. 8 to 11, introduces a structural difference: the engaged portion 21f and the engaging portion 11c are replaced with an engaged portion 7 and an engaging portion 8. Common components retain their original reference numbers, and their description are omitted for brevity. The engaged portion 7 has a side plate member 7a that is perpendicularly erected on the flat portion 21n (in the upper part of the base portion 21b of the side support member 21). The side plate member 7a extends in a front-upper direction and features a square hole 7b through its thickness. Conversely, the engaging portion 8 is formed by a main plate member 8a, which is perpendicularly erected on the rear surface of the main support member 11. The main plate member 8a extends in a rear-down direction and has a columnar projection 8b. The columnar projection 8b is uniquely shaped, resembling a columnar body (formed by two intersecting isosceles triangular plates with coinciding central axis) with its apex side portion cut by a perpendicular plane. The front, rear, right and left surfaces of the projection 8b are inclined, facilitating easy engagement with the hole 7b of the engaged portion 7. For clarity, the side plate member 7a and the projection 8b correspond to the “plate-shaped portion” and “columnar portion” described in the claims.

The embodiments configured as described above have the following effects. With the main member 10 and each side member 20 attached to the frame 4, the upper part of the main member 10 and the upper part of each side member 20 are overlapped front to rear, and the projection 8b of the engaging portion 8 of the main support member 11 are engaged with the hole 7b of the engaged portion 7 of each side support member 21. This makes it possible to stop the upper part of the main member 10 and the upper part of the side member 20 from moving relative to each other in the front-rear and right-left directions. Therefore, each engaging part 8 can be smoothly engaged with each engaged part 7. Furthermore, the gap between the upper part of the main member 10 and the upper part of the side member 20 can be more reliably kept constant. Therefore, damage to the external appearance is suppressed.

In one embodiment, when the side members and the main member are attached to the frame, the upper part of the main support member overlaps the upper part of the side support member from the front. The engaged portion is box-shaped, opens upward, and is located on the front surface of the upper part of the side support member. The engaging portion is hook-shaped, opens downward, and is located on the rear surface of the upper part of the main support member.

Therefore, with the main member and each side member attached to the frame, the hook-shaped engaging portion of the main support member is engaged with the box-shaped engaging portion of the side support member when the upper part of the main member and the upper part of each side member are overlapped. Thereby, the upper part of the main member and the upper part of each side member can be stopped from moving relative to each other in the front-rear and right-left directions. This more steadily keeps the gap between the upper part of the main member and the upper part of each side member constant. Therefore, damage to the external appearance is suppressed.

In another embodiment, the side members and the main member are attached to the frame, with the upper part of the main support member overlapping the upper part of the side support member from the front. The engaged portion on the front surface of the upper part of the side support member is a plate-shaped portion with a rectangular hole. The engaging portion on the rear surface of the upper part of the main support member is a columnar portion with a cross-shaped cross-section, extending downward and configured to be inserted into the hole. This also prevents relative movement and maintains a consistent gap.

Therefore, with the main member and each side member attached to the frame, one of the cross-shaped columnar portions of the main support member is engaged with each rectangular-shaped hole in the engaged portion of the side support member when the upper part of the main member and the upper part of each side member are overlapped. This stops the upper part of the main member and the upper part of each side member from moving relative to each other in the front-rear and right-left directions. This allows the gap between the upper part of the main member and the upper part of each side member to be more steadily maintained at a constant. Therefore, damage to the external appearance is suppressed.

Although certain embodiments have been described above, the present disclosure is not limited to their appearance and configuration, and various changes, additions, and deletions are possible to the extent that they do not alter the gist of the invention. For example, the following are examples.

According to the above embodiments, the main support member 11 overlaps each side support member 21, and the engaged portions 21f, 7 and the engaging portions 11c, 8 are arranged at the portions where the main support member 11 overlaps each side support member 21. However, not limited to this, an extension portion can be arranged from each side support member 21 in the direction of the main support member 11, and an engaging portion can be arranged on the main support member 11 with this extension portion as the engaged portion.

According to the above embodiments, the present disclosure is applied to the seat back 3 of the automobile seat 1, but may also be applied to a seat of a railway vehicle.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat back, and/or methods of making and using the same.

What is claimed is:

1. A seat back comprising:
a frame that forms a framework; and
a cushion member that is attached to the frame and elastically supports a seater, wherein the cushion member includes
a main member at the center portion in a seat width direction, and
a pair of side members located on both sides of the main member,
wherein the main member includes a main pad, a main cover that covers the main pad, and a main support member that is attached to the frame side of the main pad and supports the main pad,
wherein each of the pair of side members includes a side pad, a side cover that covers the side pad, and a side support member that is attached to the frame side of the side pad and supports the side pad,
wherein a pair of right and left engaging portions are located on the upper part of the main support member, and
wherein an engaged portion that is engaged with one of the engaging portions is formed on the upper part of each of the side support members, and each engaging portion engages against one of the respective engaged portions, and the main support member and each side support member are disabled from moving each other in the front-rear and right-left directions.

2. The seat back according to claim 1, wherein the side support members and the main support member are attached to the frame, and wherein an upper part of the main support member is configured to overlap an upper part of the side support member.

3. The seat back according to claim 1, wherein the engaged portion is located on the front surface of the upper part of the side support member and has a box-shape that opens upward.

4. The seat back according to claim 1, wherein the engaging portion is located on the rear surface of the upper part of the main support member, and wherein the engaging portion is hook-shaped that opens downward.

5. The seat back according to claim 1, wherein the side members and the main member are attached to the frame, wherein the upper part of the main support member is configured to overlap the upper part of the side support member, wherein the engaged portion located on a front surface of the upper part of the side support member has a plate-shaped portion with a rectangular-shaped hole, and wherein the engaging portion located on a rear surface of the upper part of the main support member has a columnar portion with a cross-shaped cross section extending downward being configured to be inserted into the hole.

6. A seat back comprising:
a frame that forms a framework; and
a cushion member attached to the frame, wherein the cushion member includes
a main member located at the center portion, the main member includes a main pad, a main cover that covers the main pad, and a main support member that is attached to the frame side of the main pad and supports the main pad,
a pair of side members located on both sides of the main member, each of the pair of side members includes a side pad, a side cover that covers the side pad, and a side support member attached to the frame side of the side pad and supports the side pad, and
an engagement mechanism having a plurality of engaging portions connected with a plurality of the engaged portions of the side support member.

7. The seat back according to claim 6 further comprises a pair of right and left airbag devices assembled to an outer surface of the side frames of the frame, wherein each of the side members is configured to cover one of the airbag devices.

8. The seat back according to claim 6, wherein the side support member includes a through-hole configured to receive one of the airbag devices, and wherein the side support member further comprises a weakened portion configured to rupture upon deployment of the airbag device for allowing a portion of the side support member to deform.

9. The seat back according to claim 8, wherein the weakened portion includes an outer bending portion having a thinner wall thickness, and wherein the weakened portion is configured to rupture when a load is applied by airbag deployment.

10. The seat back according to claim 6, wherein the engaging portion is located on an upper part of the main support member, and wherein the engaging portion is hook-shaped.

11. The seat back according to claim 6, wherein the engaged portion is located on an upper part of the side support member, and wherein the engaged portion is box-shaped that opens upward.

12. The seat back according to claim 6, wherein the engaged portion is plate-shaped having a rectangular hole.
